(19) United States
(12) Patent Application Publication
(10) Pub. No.: US 2017/0160751 A1
(43) Pub. Date: Jun. 8, 2017

(54) SYSTEM AND METHOD FOR CONTROLLING DRONE MOVEMENT FOR OBJECT TRACKING USING ESTIMATED RELATIVE DISTANCES AND DRONE SENSOR INPUTS

(71) Applicant: Pilot AI Labs, Inc., Sunnyvale, CA (US)

(72) Inventors: Brian Pierce, Santa Clara, CA (US); Elliot English, Stanford, CA (US); Ankit Kumar, San Diego, CA (US); Jonathan Su, San Jose, CA (US)

(73) Assignee: Pilot AI Labs, Inc., Sunnyvale, CA (US)

(21) Appl. No.: 15/369,733

(22) Filed: Dec. 5, 2016

Related U.S. Application Data
(60) Provisional application No. 62/263,510, filed on Dec. 4, 2015.

(51) Int. Cl. G05D 1/10; B64C 39/02

(52) U.S. Cl. CPC G05D 1/101; B64C 39/024; B64C 2201/127

(57) ABSTRACT

According to various embodiments, a method for controlling drone movement for object tracking is provided. The method comprises: receiving a position and a velocity of a target; receiving sensor input from a drone; determining an angular velocity and a linear velocity for the drone; and controlling movement of the drone to track the target using the determined angular velocity and linear velocity.

### CROSS REFERENCE TO RELATED PATENTS

This application claims priority under 35 U.S.C. §119(e) to U.S. Provisional Application No. 62/263,510, filed Dec. 4, 2015, entitled SYSTEM AND METHOD FOR CONTROLLING DRONE MOVEMENT FOR OBJECT TRACKING USING ESTIMATED RELATIVE DISTANCES AND DRONE SENSOR INPUTS, the contents of which are hereby incorporated by reference.

### TECHNICAL FIELD

The present disclosure relates generally to machine learning algorithms, and more specifically to controlling drone movement using machine learning algorithms.

### BACKGROUND

Drones are very useful tools for tracking objects remotely. However, most drone tracking systems are inefficient and provide for “jerky” drone flying movements, especially with a moving target. Thus, there is a need for better and more efficient drone tracking systems that provide smooth object tracking.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms for improved object detection by a neural network. According to various embodiments, a method for controlling drone movement for object tracking is provided. The method comprises: receiving a position and a velocity of a target; receiving sensor input from a drone; determining an angular velocity and a linear velocity for the drone; and controlling movement of the drone to track the target using the determined angular velocity and linear velocity.

In another embodiment, a system for controlling drone movement for object tracking is provided. The system comprises a drone, an interface for controlling movement of the drone, one or more processors, and memory. The memory stores one or more programs comprising instructions to: receive a position and velocity of a target; receive sensor input from a drone; determine angular velocity and a linear velocity for the drone; and control movement of the drone to track the target using the determined angular velocity and linear velocity.

In yet another embodiment, a non-transitory computer readable medium is provided. The computer readable medium storing one or more programs comprising instructions to: receive a position and velocity of a target; receive sensor input from a drone; determine angular velocity and a linear velocity for the drone; and control movement of the drone to track the target using the determined angular velocity and linear velocity.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a particular example of tracking a target with a drone, in accordance with one or more embodiments.

FIG. 2 illustrates a particular example of distance and velocity estimation by a neural network, in accordance with one or more embodiments.

FIG. 3 illustrates an example of object recognition by a neural network, in accordance with one or more embodiments.

FIGS. 4A and 4B illustrate an example of a method for distance and velocity estimation of detected objects, in accordance with one or more embodiments.

FIG. 5 illustrates one example of a neural network system that can be used in conjunction with the techniques and mechanisms of the present disclosure in accordance with one or more embodiments.

FIG. 6 illustrates one example of a drone system that can be used in conjunction with the techniques and mechanisms of the present disclosure in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

According to various embodiments, a method for controlling drone movement for object tracking is provided. The method comprises: receiving a position and a velocity of a target; receiving sensor input from a drone; determining an angular velocity and a linear velocity for the drone; and controlling movement of the drone to track the target using the determined angular velocity and linear velocity.

### Example Embodiments

In various embodiments, the system provides inputs to a drone controller, for the purpose of tracking a moving target. It is assumed that there is an accurate estimate of the target's position and velocity relative to the drone or other image source. In various embodiments, is the system includes an interface by which to control the linear and angular velocity of the drone. In some embodiments, the system controls the drone's velocity in order to track a moving target.

### Description of the Control Algorithm

In some embodiments, the system is able to track a target moving at relatively high speeds (up to the drone's maximum velocity). Additionally, it follows the drone smoothly, without exhibiting “jumpy” behavior, as is often seen by drones tracking targets. The system accomplishes this by taking into account both the desired location of the drone relative to the target, as well as an estimate velocity of the target.

In some embodiments, attempts to control a drone have only used the desired location of the drone relative to the target, and use a control algorithm to try to move the drone such that it is in its desired position relative to the target (e.g. 5 meters away horizontally, and 1 meter above vertically). However, if the target is moving quickly, the desired location of the drone will change quickly, and the drone will often have difficulty keeping up with the target. Another issue arises when the target stops suddenly. An algorithm which only takes into account the position of the drone and the position of the target will fail if the target slows down too quickly, because the drone will get to its desired offset from the target, but when it arrives, it could be moving very fast, and therefore have difficulty slowing down and maintaining the desired offset from the target. Incorporating the target's linear velocity into the control algorithm solves these problem cases.

In some embodiments, an example algorithm is as follows. It is assumed that the target's position (_(xₜ)) and velocity (_(vₜ)) relative to the drone are given. In some embodiments, the position and velocity of the moving target may be calculated by a position estimation system as described in the U.S. Patent Application entitled SYSTEM AND METHOD FOR IMPROVED DISTANCE ESTIMATION OF DETECTED OBJECTS filed on Dec. 5, 2016, which claims priority to U.S. Provisional Application No. 62/263,496, filed Dec. 4, 2015, of the same title, each of which are hereby incorporated by reference.

In addition, the sensor input from the drone which describes its current orientation is also given. In some embodiments, the drone requires specification of an angular and linear velocity. The angular velocity has the three standard components: yaw, pitch and roll. To maintain stability, the pitch and roll velocity are fixed to 0. The yaw velocity is set to be some constant value (P) multiplied by the difference between the target's yaw angle and the drone's yaw angle. The equation is:

_ω_{d}=(P(αₜ−α_{d}), 0, 0)

where _(ω_{d}) is the angular velocity vector of the drone, αₜ is the yaw angle of the target and α_{d} is the yaw angle of the drone.

Thus, if the target's yaw angle and the drone's yaw angle are the same, the difference between the two will be zero, and consequently the drone's angular velocity will be zero. Conversely, if the target's yaw angle is greater than the drone's yaw angle, the yaw velocity will be positive, thus the drone's yaw angle will increase and move closer to the target's yaw angle.

The algorithm for the linear velocity contains one component that is similar to the angular velocity algorithm detailed above, but it also contains a second component. Specifically, the first component of the algorithm includes a term which multiplies the constant P by the difference between the desired position relative to the target (called the offset position, _x₀, as the term target position refers to the location of the target object) and the drone position. This is the term that is often used in drone object tracking controllers. A second term is included as well, namely the target's estimated linear velocity, _(vₜ). Combining the two terms, the equation for the linear velocity specified to the drone is:

_(v_{d})=_(vₜ)+P(_xₜ−_(x_{d}))

where _(v_{d}) is the linear velocity of the drone (specified as part of the controller) and _(x_{d}) is the drone's position. If the target's linear velocity is zero, then the scenario is the same as above for the angular velocity. When the drone's position is equal to the offset position, the drone's linear velocity will be zero. If the drone's position is not equal to the offset position, the drone will move towards the offset position. However, if the target's linear velocity is not zero, there are more challenging cases. For example, consider the case that the target's linear velocity is non-zero and the drone's position is equal to the offset position. In that case, the drone's linear velocity will simply be equivalent to the target's linear velocity. The velocity term is necessary due to the unstable nature of controlling the linear velocity. Unlike controlling the angular velocity, which naturally lends itself to smooth control, the linear velocity controller tends to be unstable because it is particularly sensitive to any noise in the offset position. The linear acceleration is a jerkier motion for the drone than the angular acceleration.

The velocity term makes it such that the object does not need to be far away from the drone for the drone to start moving. During the development of the drone controller, experiments excluding the target velocity term in the control algorithm yielded noticeably unstable tracking, particularly when the target moved at higher velocities. In other words, including the target's linear velocity in the equation above, the drone's movement may be smoother than without including the target's linear velocity. This is because without considering the target's linear velocity, the system only reacts to the movement of the target, instead of predicting the movement of the target and, in effect, the drone's movement may be delayed. By including the target's linear velocity, a more accurate prediction of the target's movement and speed can be estimated, allowing the system to preemptively move the drone and cause the movement of the drone relative to the target to be smoother.

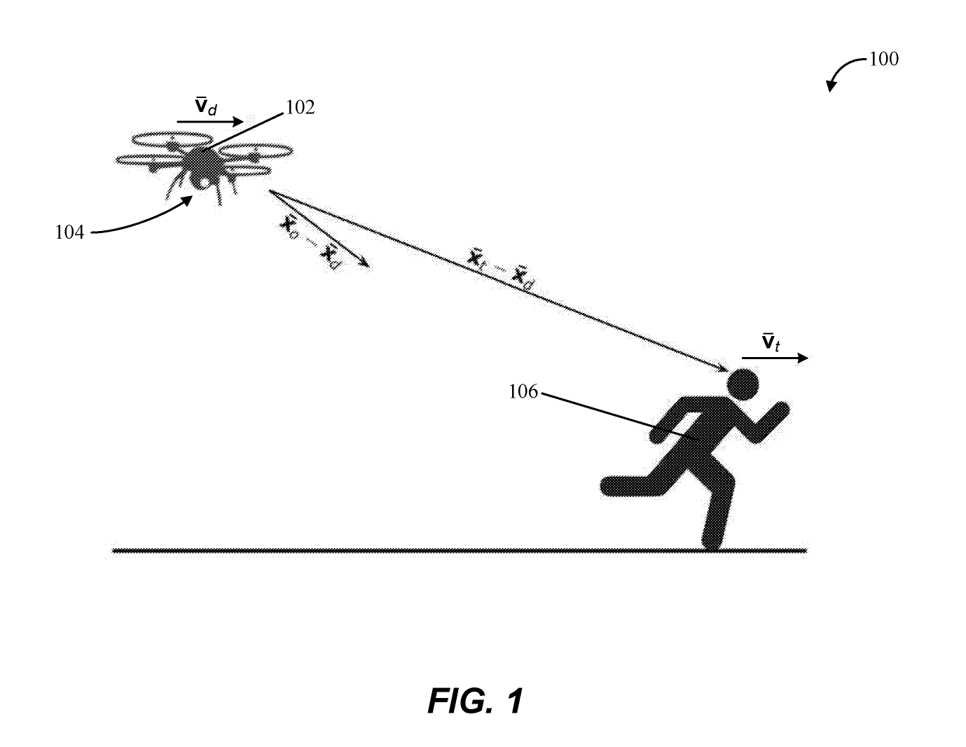

FIG. 1 illustrates a diagram 100 of the physical interpretation of some of the variables that go into the drone control algorithm for following a target. The drone 102 is located some distance away from the target 106. In some embodiments, drone 102 includes a camera 104 to record images as input. As shown in FIG. 1, target 106 is a person. The target 106 is moving with a velocity vₜ. The vector that points from the drone 102 to the target 106 is xₜ−x_{d}, where xₜ is the vector location of the target, and x_{d}is the vector of the drone. The other vector depicted (xₒ−x_{d}) shows the difference between where the drone should be located relative to the target where the drone is currently located. The drone's velocity v_{d} (which the system specifies via the control algorithm) is a function of both the target velocity vₜand the difference between the drone's desired offset from the target and its current location.

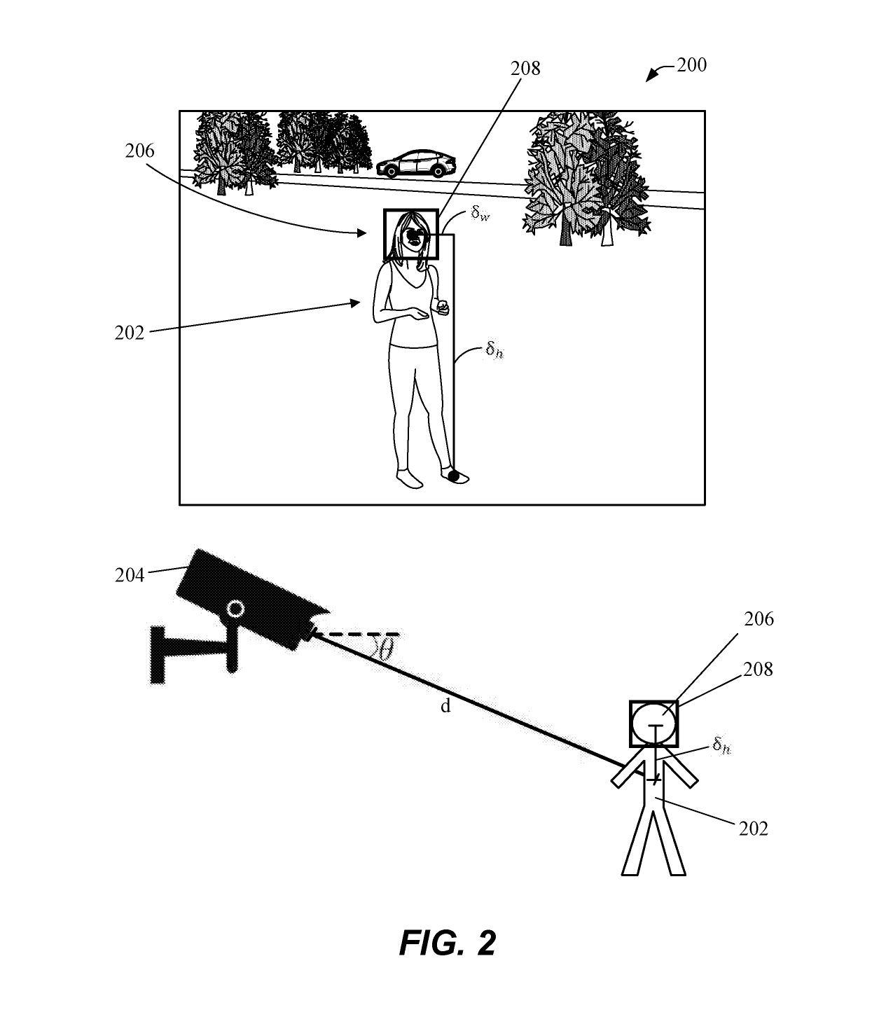

FIG. 2 illustrates an example of some of the variables that are used to estimate distance and velocity that may be used in the drone control algorithm described in FIG. 1. An input image 200 may be an image of a person 202. The input image 200 is passed through a neural network to produce a bounding box 208 around the head 206 of person 202. In various embodiments, such bounding box may be produced by a neural network detection system as described in the U.S. Patent Application titled SYSTEM AND METHOD FOR IMPROVED GENERAL OBJECT DETECTION USING NEURAL NETWORKS filed on Nov. 30, 2016 which claims priority to U.S. Provisional Application No. 62/261,260, filed Nov. 30, 2015, of the same title, each of which are hereby incorporated by reference.

The image pixels within bounding box 208 are also passed through a neural network to associate each bounding box with a unique identifier, so that the identity of each object within the bounding box is coherent from one frame to the next (although only a single frame is illustrated in FIG. 2). As such, an object may be tracked from one frame to the next. In various embodiments, such tracking may be performed by a tracking system as described in the U.S. Patent Application entitled SYSTEM AND METHOD FOR DEEP-LEARNING BASED OBJECT TRACKING filed on Dec. 2, 2016 which claims priority to U.S. Provisional Application No. 62/263,611, filed on Dec. 4, 2015, of the same title, each of which are hereby incorporated by reference.

The location from the center of the bounding box to the center of the image is measured, for both the horizontal coordinate (δ_{w}) and the vertical coordinate (δₕ). The image 200 may be recorded by a camera 204. In some embodiments, camera 204 may be camera 104 on drone 102. The angle θ that the camera makes with a horizontal line is depicted, as well as the straight-line distance d between the camera lens and the center of the image.

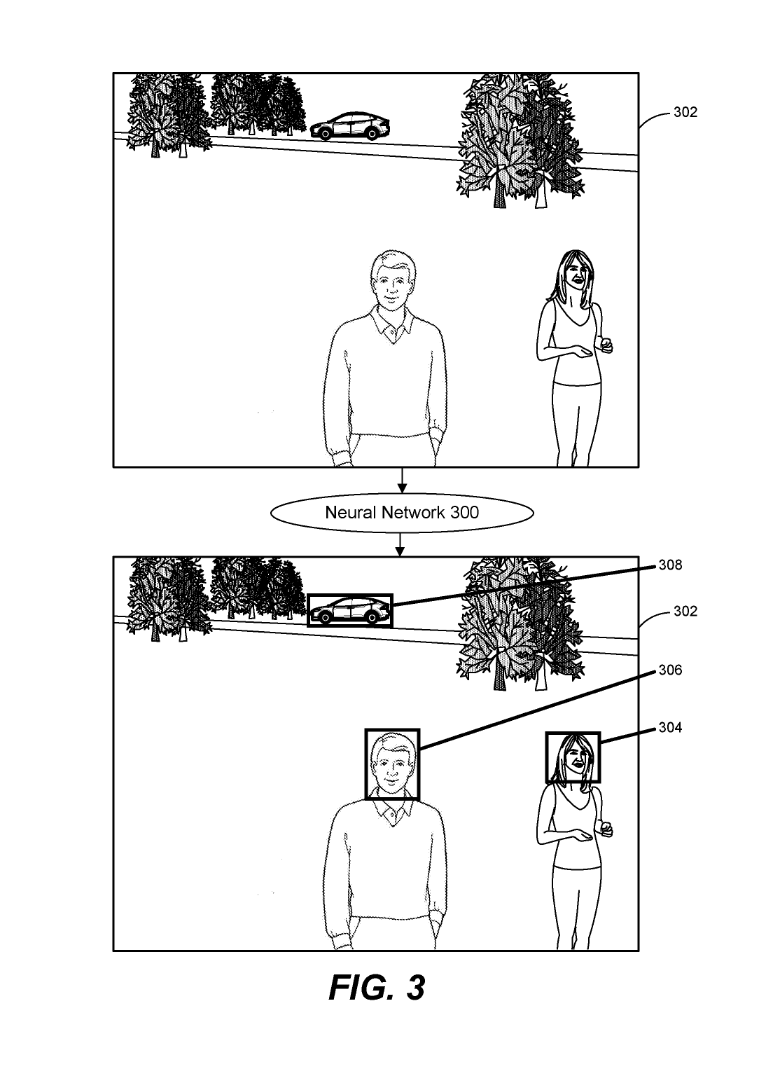

FIG. 3 illustrates bounding boxes that may be produced by a neural network 300. As previously described, such bounding boxes may be produced by a neural network detection system as described in the U.S. Patent Application titled SYSTEM AND METHOD FOR IMPROVED GENERAL OBJECT DETECTION USING NEURAL NETWORKS, referenced above. Image pixels 302 may be input into neural network 300 as a third order tensor. Neural network 300 may produce minimal bounding boxes around identified objects of various types. For example, boxes 304 and 306 are output around human faces, and box 308 is output around a car. In some embodiments neural network 300 may be implemented to produce bounding box 208 around the head 206 of person 202 in FIG. 2.

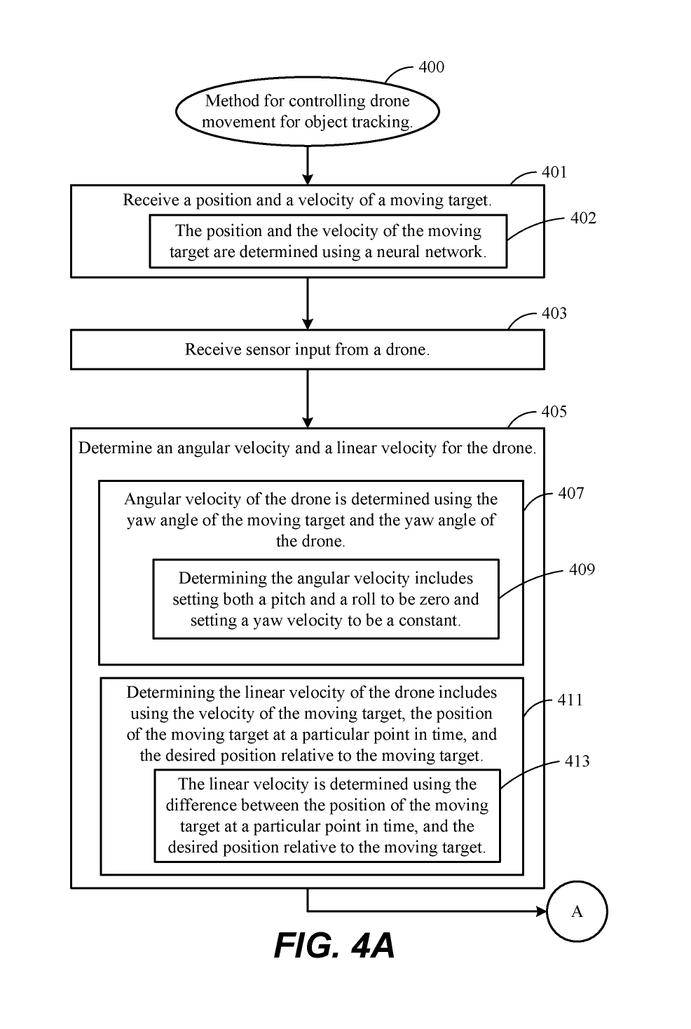

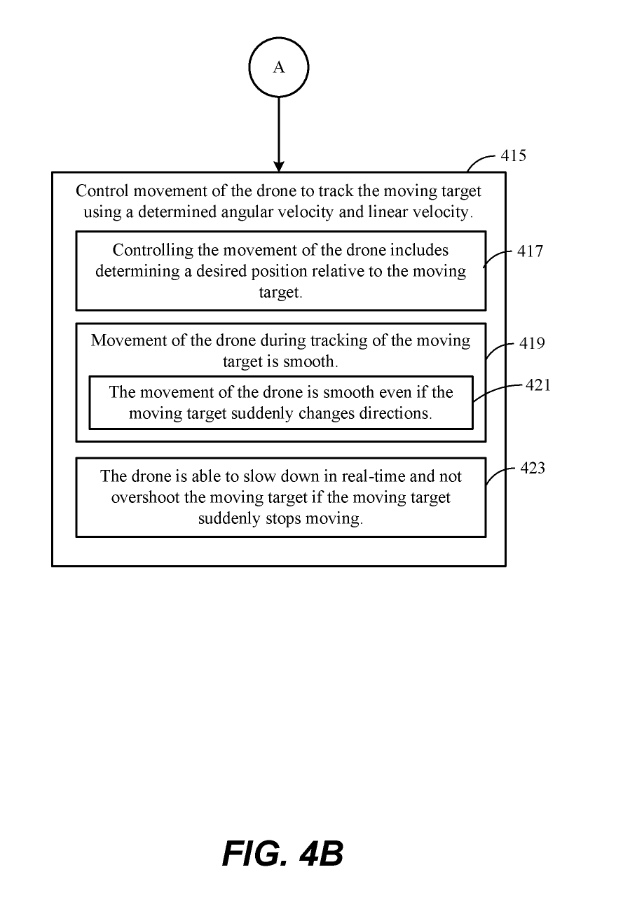

FIG. 4A and FIG. 4B illustrate an example of a method 400 for controlling drone movement for object tracking. At 401 a position and a velocity of a moving target is received. In some embodiments, the position and the velocity of the moving target are determined using a neural network 402. In some embodiments, the moving target may be target 106 and may be a person, as shown in FIG. 1. As previously described, a moving target may be an identified object, which is identified by a neural network detection system described in the U.S. Patent Application titled SYSTEM AND METHOD FOR IMPROVED GENERAL OBJECT DETECTION USING NEURAL NETWORKS, referenced above. Furthermore, such object may be tracked through multiple image sequences captured by a camera, such as camera 104 on drone 102. Such object tracking may be performed by a tracking system as described in the U.S. Patent Application entitled SYSTEM AND METHOD FOR DEEP-LEARNING BASED OBJECT TRACKING, referenced above.

In various embodiments, the position and velocity of the moving target may be calculated by a position estimation system as described in the U.S. Patent Application entitled SYSTEM AND METHOD FOR IMPROVED DISTANCE ESTIMATION OF DETECTED OBJECTS, previously referenced above. For example, based on an identified and tracked object, such as the moving target, a position estimation system may calculate a noisy estimate of the physical position of the moving target to a source of the image, such as camera 104 on drone 102. A noisy estimate may be calculated for the moving target in each image frame captured by camera 104 and stored in a database and/or memory. Using the calculated noisy estimates, the position estimation system may produce a smooth estimate of the physical position of the moving target, as well as a smooth estimate of the velocity of the moving target. As such, an accurate estimate of the moving target's position and velocity relative to the drone may be determined and utilized at step 401.

At 403, sensor input from a drone is received. In some embodiments, the drone may be drone 102 with camera 104. In various embodiments, sensor input from drone 102 may include direction and velocity of travel, airspeed, elevation, distance from the moving target, etc. In some embodiments, the sensor input from the drone describes the current orientation of the drone. At 405, an angular velocity 407 and a linear velocity 411 are determined for the drone. In some embodiments angular velocity 407 is determined using the yaw angle of the moving target and the yaw angle of the drone. In further embodiments, determining the angular velocity 407 includes setting 409 both a pitch and a roll to be zero and setting a 409 a yaw velocity to be a constant. In some embodiments, determining the linear velocity 411 of the drone includes using the velocity of the moving target, the position of the moving target at a particular point in time, and the desired position relative to the moving target. In further embodiments, the linear velocity 411 is determined using the difference between the position of the moving target at a particular point in time and the desired position relative to the moving target.

Using a determined angular velocity 407 and linear velocity 411, movement of the drone to track the moving target is controlled at 415. In some embodiments, controlling the movement of the drone includes determining a desired position 417 relative to the moving target. In other embodiments, movement of the drone during tracking of the moving target is smooth 419.

As previously described above, including the target's linear velocity in determining the linear velocity 411 of the drone allows the system to predict the moving target's movement and velocity. This in turn may allow the system to preemptively move the drone toward the desired position 417 relative to the moving target rather than reacting to the movement of the moving target, which may cause a delay in the drone's movement. This may effectively cause the drone's movement to to the desired position 417 to be smoother and more consistent.

In various embodiments, such predictive capability allows the system to anticipate a change in direction of the moving target. Thus, the movement of the drone may be smooth 419 even if the moving target suddenly changes direction 421. In further embodiments, such predictive capability allows the system to anticipate acceleration and/or deceleration of the moving target. In some embodiments, such predictive capability may allow the drone to change direction and/or speed to correspond to changes in direction and/or speed of the moving target in real-time. Thus, in some embodiments, the drone is able to slow down 423 in real-time and not overshoot the moving target if the moving target suddenly stops moving. Existing methods and systems that do not use the velocity of the moving target may not allow the drone to react quickly enough and result in the drone to overshoot, or travel past a moving target that stops movement or changes direction significantly.

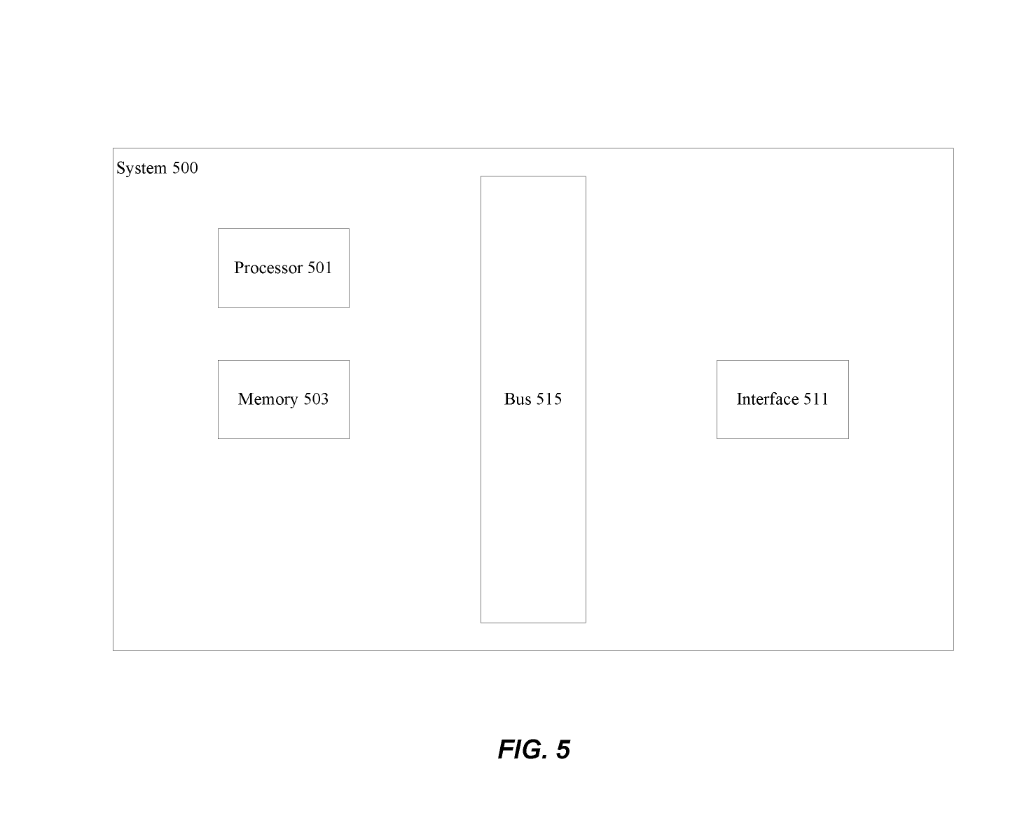

FIG. 5 illustrates one example of a neural network system 500, in accordance with one or more embodiments. According to particular embodiments, a system 500, suitable for implementing particular embodiments of the present disclosure, includes a processor 501, memory 503, an interface 511, and a bus 515 (e.g., a PCI bus or other interconnection fabric) and operates as a streaming server. In some embodiments, when acting under the control of appropriate software or firmware, the processor 501 is responsible for various processes, including processing inputs through various computational layers and algorithms. Various specially configured devices can also be used in place of a processor 501 or in addition to processor 501. The interface 511 is typically configured to send and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 500 uses memory 503 to store data and program instructions for operations including training a neural network, object detection by a neural network, and distance and velocity estimation. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

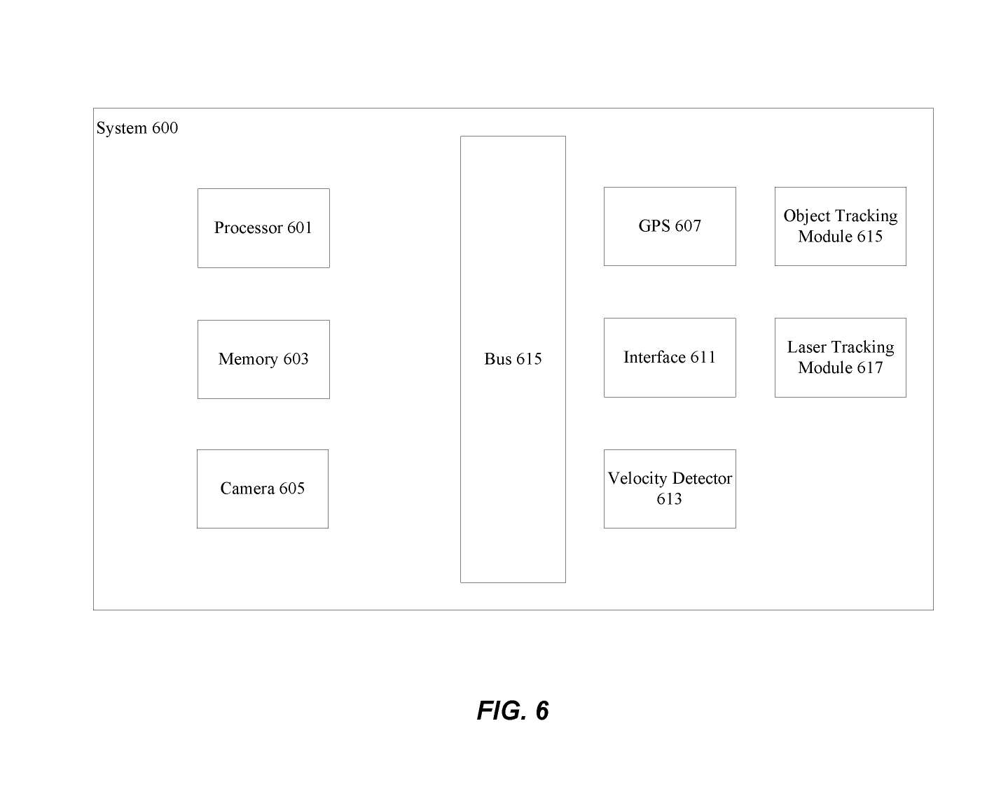

FIG. 6 illustrates one example of a drone system 600 that can be used in conjunction with the techniques and mechanisms of the present disclosure in accordance with one or more embodiments. In various embodiments, drone system 600 may be drone 102 previously described with reference to FIG. 1. However, in other embodiments, various elements of drone system 600 may correspond to separate components, including drone 102, a server, a controller, etc. According to particular embodiments, a drone system 600, suitable for implementing particular embodiments of the present disclosure, includes a processor 601, memory 603, an interface 611, and a bus 615 (e.g., a PCI bus or other interconnection fabric) and may operate as a streaming server. In some embodiments, when acting under the control of appropriate software or firmware, the processor 601 is responsible for various processes, including processing inputs through various computational layers and algorithms. Various specially configured devices can also be used in place of a processor 601 or in addition to processor 601. The interface 611 is typically configured to send and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the drone system 600 uses memory 603 to store data and program instructions for operations including training a neural network, object detection by a neural network, and distance and velocity estimation. The program instructions may control the operation of an operating system and/or one or more applications, for example. The memory or memories may also be configured to store received metadata and batch requested metadata.

Drone system 600 may further include camera 605, global position system 607, velocity detector 613, object tracking module 615, and laser tracking module 617. In some embodiments, camera 605 may be camera 104 which may be used to capture a series of images of the surrounding area of drone 102. The series of images may include an object, such as a moving target. In some embodiments, the captured images may be input into various neural networks and/or computational systems, which may be implemented by object tracking module 615. For example, object tracking module may be configured to process a neural network detection system, a tracking system, and/or a position estimation system, as previously described in the various patent applications, incorporated by reference herein, to identify and track the moving target, and thereby estimate its position and velocity from drone 102. Such position and velocity of the moving target may be utilized by various steps in method 400, such as step 401.

Drone system 600 may further include a global position system 607. In other embodiments, drone system 600 may include various other types of positioning system, such as a local positioning system. Velocity detector 613 may be used to determine the velocity of drone system 600. In some embodiments, velocity detector 613 may be an airspeed indicator which can measure the difference in pressure between the air around the craft and the increased pressure caused by propulsion. In some embodiments, velocity detector 613 may be used in conjunction with global position system 607 to determine the position, velocity, and/or direction of travel for drone system 600. Laser tracking module 617 may also be used to determine the position of drone system 600 relative to an object, such as the moving target. Such measurements may be sensor inputs utilized at various steps of method 400, such as step 403.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for controlling drone movement for object tracking, the method comprising:
receiving a position and a velocity of a moving target;
receiving sensor input from a drone;
determining an angular velocity and a linear velocity for the drone; and
controlling movement of the drone to track the moving target using the determined angular velocity and linear velocity.

2. The method of claim 1, wherein the movement of the drone during tracking of the moving target is smooth.

3. The method of claim 1, wherein the angular velocity of the drone is determined using the yaw angle of the moving target and the yaw angle of the drone.

4. The method of claim 1, wherein controlling the movement of the drone includes determining a desired position relative to the moving target.

5. The method of claim 4, wherein determining the linear velocity of the drone includes using the velocity of the moving target, the position of the moving target at a particular point in time, and the desired position relative to the moving target.

6. The method of claim 5, wherein the linear velocity is determined using the difference between the position of the moving target at a particular point in time and the desired position relative to the moving target.

7. The method of claim 1, wherein the movement of the drone is smooth even if the moving target suddenly changes directions.

8. The method of claim 1, wherein the drone is able slow down in real-time and not overshoot the moving target if the moving target suddenly stops moving.

9. The method of claim 1, wherein determining the angular velocity includes setting both a pitch and a roll to be zero and setting a yaw velocity to be a constant.

10. The method of claim 1, wherein the position and the velocity of the moving target are determined using a neural network.

11. A system for controlling drone movement for object tracking, comprising:
a drone;
an interface for controlling movement of the drone;
one or more processors;
memory; and
one or more programs stored in the memory, the one or more programs comprising instructions for:
receiving a position and a velocity of a moving target;
receiving sensor input from a drone;
determining an angular velocity and a linear velocity for the drone; and
controlling movement of the drone to track the moving target using the determined angular velocity and linear velocity.

12. The system of claim 11, wherein the movement of the drone during tracking of the moving target is smooth.

13. The system of claim 11, wherein the angular velocity of the drone is determined using the yaw angle of the moving target and the yaw angle of the drone.

14. The system of claim 11, wherein controlling the movement of the drone includes determining a desired position relative to the moving target.

15. The system of claim 14, wherein determining the linear velocity of the drone includes using the velocity of the moving target, the position of the moving target at a particular point in time, and the desired position relative to the moving target.

16. The system of claim 15, wherein the linear velocity is determined using the difference between the position of the moving target at a particular point in time and the desired position relative to the moving target.

17. The system of claim 11, wherein the movement of the drone is smooth even if the moving target suddenly changes directions.

18. The system of claim 11, wherein the drone is able slow down in real-time and not overshoot the moving target if the moving target suddenly stops moving.

19. The system of claim 11, wherein determining the angular velocity includes setting both a pitch and a roll to be zero and setting a yaw velocity to be a constant.

20. A non-transitory computer readable storage medium storing one or more programs configured for execution by a computer, the one or more programs comprising instructions for:
receiving a position and a velocity of a moving target;
receiving sensor input from a drone;
determining an angular velocity and a linear velocity for the drone; and
controlling movement of the drone to track the moving target using the determined angular velocity and linear velocity.
